(19) United States
(12) Patent Application Publication
(10) Pub. No.: US 2026/0196362 A1
(43) Pub. Date: Jul. 9, 2026

(54) HEAT-SINK CHAMBER FOR A PLASMA-CONFINEMENT DEVICE

(71) Applicant: Leonid E. Zakharov, Princeton, NJ (US)

(72) Inventor: Leonid E. Zakharov, Princeton, NJ (US)

(21) Appl. No.: 19/417,845

(22) Filed: Dec. 12, 2025

Related U.S. Application Data
(60) Provisional application No. 63/833,065, filed on Jan. 8, 2025.

(51) Int. Cl. G21B 1/11; G21B 1/05

(52) U.S. Cl. CPC G21B 1/13; G21B 1/115; G21B 1/05

(57) ABSTRACT

Systems and methods related to plasma-confinement devices are disclosed. A heat-sink chamber for a plasma-confinement device includes a base and a heat-sink structure protruding from the base. The heat-sink structure includes one or more heat sinks disposed on a surface of the heat-sink structure and configured to absorb thermal energy. The heat-sink structure further includes a lithium distributor configured to provide a flow of lithium to one or more surfaces of the heat-sink structure and at least one magnet configured to generate a magnetic field. The generated magnetic field includes a closed flux surface configured to confine a plasma and open field lines outside of the closed flux surface, the open field lines terminating at the one or more heat sinks.

### RELATED APPLICATIONS

This patent application is related to and claims priority to U.S. Provisional Patent Application No. 63/833,065, filed on Jan. 8, 2025, which is hereby incorporated by reference in its entirety.

### FIELD

Embodiments of the present invention relate generally to plasma physics and, more particularly, to fusion reactors.

### BACKGROUND

Fusion power is a proposed form of electrical power generation that generates electricity by using heat from nuclear fusion reactions. In a fusion process, two lighter atomic nuclei combine to form a heavier nucleus, while releasing energy. Devices designed to harness this energy are known as fusion reactors. Research into fusion reactors began in the 1940s, but as of 2024, no device has reached net power, although net positive reactions have been achieved.

Nuclear fusion has a number of potential advantages compared to fission. These include little high-level waste, and increased safety. However, the necessary combination of temperature, pressure, and duration has proven to be difficult to produce in a practical and economical manner. A tokamak is type of magnetic plasma-confinement device which features quasi-stationary plasma confinement within an axisymmetric toroidal magnetic configuration. Tokomaks are currently one of the leading candidates for a practical fusion reactor. However, tokomaks to date have been unable to achieve net positive reactions for a variety of reasons, including plasma instabilities and particle recycling. This document describes improvements that address at least some of the issues described above.

### SUMMARY

The present disclosure describes embodiments related to plasma-confinement devices such as fusion reactors, and particularly to a heat-sink chamber for a plasma-confinement device. In an embodiment, a heat-sink chamber for a plasma-confinement device includes a base and a heat-sink structure protruding from the base. The heat-sink structure includes one or more heat sinks disposed on a surface of the heat-sink structure and configured to absorb thermal energy. The heat-sink structure further includes a lithium distributor configured to provide a flow of lithium to one or more surfaces of the heat-sink structure and at least one magnet configured to generate a magnetic field. The generated magnetic field includes a closed flux surface configured to confine a plasma and open field lines outside of the closed flux surface, the open field lines terminating at the one or more heat sinks.

Implementations of the disclosure may include one or more of the following optional features. In some examples, the chamber further includes walls extending from the base and surrounding the heat-sink structure, wherein a distance between the walls diminishes to form a waist, the waist defining an opening opposite the base of the heat-sink chamber. At least a portion of at least one wall may angle toward an opposite wall to form the waist. The one or more heat sinks may include two heat sinks disposed on opposite sides of the heat-sink structure such that the open field lines terminate at each of the two heat sinks. In some examples, the lithium distributor is configured to provide a flow of lithium to surfaces of each of the two heat sinks where the open field lines terminate. Each of the one or more heat sinks may include an actively cooled copper body and a foil brazed to a surface of the copper body, wherein the lithium distributor is configured to provide the flow of lithium to coat the foil. The lithium distributor may be configured to provide the flow of lithium using gravity.

In an embodiment, a plasma-confinement device includes a plasma-confining chamber and a heat-sink chamber adjacent to the plasma-confining chamber, wherein the opening opposite the base of the heat-sink chamber defines an opening between the plasma-confining chamber and the heat-sink chamber.

In an embodiment, a method of extracting heat from a plasma-confinement device includes disposing a plasma in a plasma-confinement device comprising a heat-sink chamber. The method further includes generating the magnetic field, providing (by a lithium distributor), a flow of liquid lithium to one or more surfaces of a heat-sink structure, and actively cooling one or more heat sinks.

Implementations of the disclosure may include one or more of the following optional features. In some examples, the method further includes maintaining side-wall temperature of the plasma-confining chamber under 250 degrees Celsius. Generating the magnetic field may include generating a magnetic field having closed magnetic field lines within the plasma-confining chamber.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 shows a cross section of an example plasma confinement device.

FIG. 2 shows another view of the example plasma confinement device.

FIG. 3 shows a close-up view of an example heat-sink chamber.

FIG. 4 shows another view of the example heat-sink chamber.

FIG. 5 shows a flowchart for an example method.

In the drawings, like reference numbers generally indicate identical or similar elements. Additionally, generally, the left-most digit(s) of a reference number identifies the drawing in which the reference number first appears.

### DETAILED DESCRIPTION

As used in this document, the singular forms “a,” “an,” and “the” include plural references unless the context clearly dictates otherwise. Unless defined otherwise, all technical and scientific terms used herein have the same meaning(s) as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such as “first” and “second” are used to modify a noun or phrase, such use is simply intended to distinguish one item from another and is not intended to require a sequential order unless specifically stated. The term “about” when used in connection with a numeric value, is intended to include values that are close to, but not exactly, the number. For example, in some embodiments, the term “about” may include values that are within +/−10 percent of the value.

The present disclosure relates generally to plasma-confinement devices such as fusion reactors, and particularly to a heat-sink chamber for a plasma-confinement device. The heat-sink chamber may be used as a component of a tokamak device, which is a type of magnetic plasma-confinement device and is currently one of the leading candidates for achieving controlled thermonuclear reactions (i.e., fusion) in high-temperature plasmas, such as deuterium-tritium (DT) plasmas. In some examples, the heat-sink chamber may be used in a stellarator or other non-tokamak fusion reactor. The creation and evolution of a hot, high-density plasma within a tokamak or similar device is referred to as a “discharge,” which typically lasts for a period of time from a few seconds to as long as a quarter of an hour.

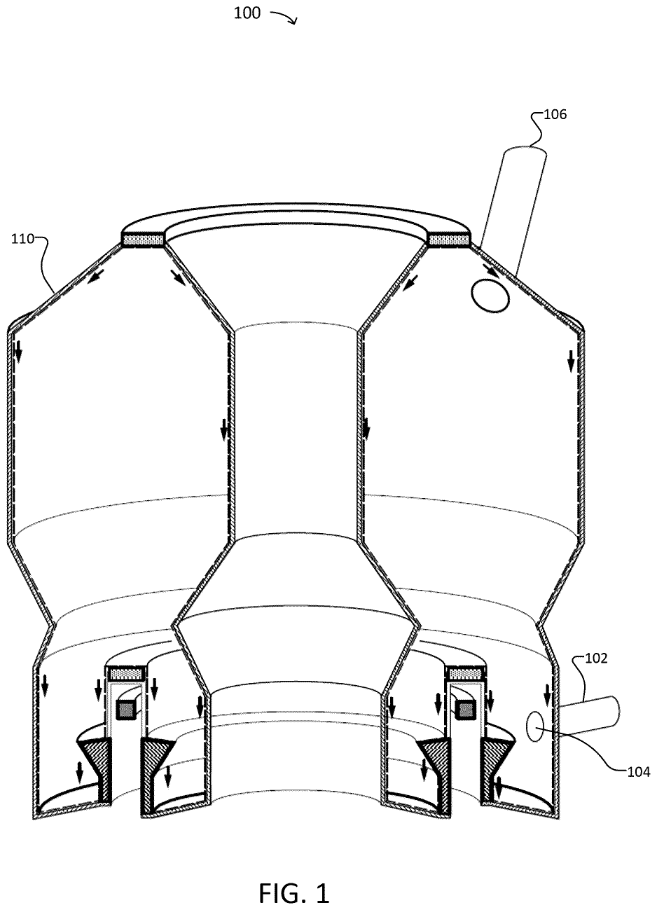

FIG. 1 shows a cross section of an example plasma confinement device 100. As shown, the device includes a torus-shaped plasma vacuum chamber 110. Walls of the plasma chamber may include materials suitable for high-vacuum use, such as stainless steel. These materials may also allow external magnetic fields to pass through them. The example plasma confinement device 100 includes one or more vacuum ports 102 or penetrations which may be used to apply a vacuum to the chamber and/or measure characteristics of the chamber, such as pressure and/or partial pressures of residual gasses in the chamber. The vacuum port 102 may be covered by a screen 104 (e.g., a metal mesh) that forms a portion of the inner wall of the plasma chamber. The example plasma confinement device 100 also includes one or more Neutral Beam Injection (NBI) ports 106, through which neutral beams may be injected to heat the plasma.

A current goal of tokomaks is to produce a sustained and controlled “burning” of the plasma and harvest the released energy for commercial purposes. Each DT fusion event during the discharge produces a helium-4 nucleus (alpha particle) and a neutron, releasing about 17.6 MeV of energy. The neutron carries approximately 80% of the total energy released in the reaction, resulting in a neutron energy of 14.1 MeV. Deuterium-deuterium (D-D) fusion releases energy in two main reactions: one yields a triton (tritium nucleus) and a proton (hydrogen nucleus), releasing 3.27 MeV, and the other yields a helium-3 nucleus and a neutron, releasing 4.03 MeV. A secondary goal is to harvest some or all energetic (e.g., 14 Mev) neutrons for producing isotopes, e.g., for medical and/or industrial uses. The energetic neutrons may also be used as a source of neutrons for neutron science experiments or for Fusion-Assisted Fast Breeder Reactors (FAFBR). However, to date, the record fusion “amplification factor” (the ratio of fusion power output to the input heating power) for a DT tokomak (denoted as Q_{DT}) is only about ⅓ (sustained over a 5-second period at the Joint European Torus (JET) in Oxfordshire, UK), which may be the most advanced tokamak built so far. I.e., the breakeven milestone of Q_{DT}=1 has been unachievable, at least partially due to high levels of the phenomenon of recycling, which is related to cooling of the plasma edges (i.e., near the walls of the confinement vessel).

In magnetic confinement fusion, a divertor includes a magnetic field configuration which diverts the heat and particles escaping from the magnetically confined plasma to dedicated plasma-facing components. That is, one or more magnets (permanent magnets, electromagnets, and/or superconducting electromagnets) produce an aggregate magnetic field in the plasma chamber, where the field is configured to control and/or confine the plasma. The magnets may be configured to produce a separatrix-bounded magnetic configuration, e.g., by creating poloidal field nulls (X-points). A tokamak featuring a divertor is known as a divertor tokamak or divertor configuration tokamak. In this configuration, the particles escape through a magnetic “gap” (separatrix), which allows the energy-absorbing part of the divertor to be placed outside the plasma. The plasma code may be heated in a variety of ways, including using high-power microwaves generated by devices like gyrotrons to interact with and heat the plasma electrons. Alternatively, or additionally, the plasma core may be heated using Neutral Beam Injection (NBI) of energetic atoms (e.g., 20-120 keV hydrogen isotopes, such as deuterium). A neutral beam may be obtained by neutralization of a precursor ion beam. In the case of a negatively charged precursor beam, neutralization may be performed by passing the ion beam through a gas cell.

During a tokamak discharge, plasma particles (ions and electrons) constantly interact with the walls and divertors. Some of these particles, instead of being lost, are re-emitted or “recycled” back into the plasma as cold atoms. These atoms, in turn, exchange electrons with the hot plasma ions, converting them into neutral atoms that escape the edge while carrying the plasma's thermal energy. This recycling process significantly impacts plasma density, temperature, and overall performance. In particular, recycling cools the plasma edge, resulting in a peaked plasma temperature profile. This, in turn, leads to several detrimental effects, including turbulent energy losses from the core, and insufficient plasma fusion performance, inefficiency of external plasma heating, deterioration of plasma stability, and challenges in the extraction of associated large heating power. This cooling can be mitigated by absorbing particles escaping the plasma, e.g., using a lithium plasma-facing surface. The process of removing particles (ions and neutrals) from plasma can be referred to as plasma pumping.

Lithium, the lightest of the alkali metals (atomic number 3), has two stable, naturally occurring, isotopes: lithium 6, and the more abundant lithium 7. Each isotope has a melting point of about 181 degrees Celsius. In this document, the term lithium describes either of these isotopes and/or combinations of these isotopes. Lithium has been shown to absorb the unburned tritium (T) and deuterium (D) escaping from the plasma. In liquid form, the lithium (including captured atoms) can be directed to a reservoir outside of the tokomak for external processing. This processing may include Real Time Tritium Recovery (RTTR) to extract tritium atoms from the liquid lithium, e.g., to help ensure that the control of tritium inventory inside the vacuum vessel within the regulatory frameworks. Recovered tritium and/or deuterium atoms may also be recycled for use in NBI.

Simulation of the interactions between plasmas and wall materials have shown that liquid lithium flowing at a rate of 2 cubic centimeters per second provide adequate pumping to effectively mitigate recycling The chief challenges of maintaining a liquid-lithium plasma-facing surface are related to properties of lithium. For example, to remain in liquid form the lithium should be above the melting point of about 181 degrees Celsius. However, as lithium is heated to higher temperatures, more lithium will evaporate. These evaporated lithium atoms may interact with the plasma, e.g., through charge exchange with ions at the edge of the plasma. Each atom of lithium vapor can expel three plasma-temperature ions via charge exchange with ions at the edge of the plasma. To mitigate this, the lithium may be kept at a temperature that is relatively close to its melting point, such as 250 degrees C. To maintain this temperature range, the outer surface of the vacuum chamber may be equipped with an active cooling system. In some examples, the cooling system uses a synthetic oil flow loop with external temperature control units. The oil may circulate in a continuous loop, e.g., driven by high-temperature pumps through pipes outside the vacuum vessel. The oil may then flow through internal channels in a copper outer shell of the plasma-chamber walls, or through manifolds brazed to the outer side of the plasma chamber. The components within the plasma chamber may be shielded to or insulated to assist in temperature regulation.

To further mitigate against evaporated lithium, the device 100 may be configured to keep the total volume of lithium within the tokomak reasonably low, e.g., by adjusting the thickness of the layer of lithium. Liquid lithium is also very reactive (although less so than other alkali metals). The lower the rate of flow of lithium, the greater the opportunity for monolayers of, e.g., lithium oxides, nitrites, and/or hydroxides to form on surfaces of the liquid lithium, e.g., due to residual outgassing from non-lithium surfaces within the tokomak. And thinner (e.g., less than 0.1 mm) layers of liquid lithium may be more susceptible to the effects of a crust forming on its surface, e.g., interfering with its smooth flow under the force of gravity. However, a thinner layer of liquid lithium is more transparent to the heat flux from plasma, allowing the heat to pass through the lithium and be absorbed by actively cooled surfaces beneath the layer of lithium. To some extent the issues due to outgassing may be mitigated through a disciplined vacuum protocol, e.g., baking surfaces after they are exposed to air. Furthermore, the effects may be mitigated by avoiding, as much as reasonably possible, exposure of the lithium surface to, e.g., stainless steel elements or other sources of outgassing.

The liquid lithium surface may be configured to continuously flow, under gravity, along the inner walls of the plasma vacuum chamber. In some examples, the inner walls may be stainless steel and may include a heat sink, e.g., a copper layer, which may be actively cooled and may be temperature controlled. By completely covering the inner wall surface (other than ports for diagnostics, NBI, or other purposes), the only plasma-facing surface is liquid lithium. The liquid lithium may be pumped to a distribution manifold at the top of the plasma chamber, e.g., by electromagnetic (EM) pumps from, e.g., an external reservoir. The distribution manifold may distribute the lithium toroidally around the plasma chamber where it moves downwardly along the side wall inner surfaces to the bottom of the chamber. The liquid lithium may “creep” along the surfaces at a rate of 1 cm/second, or even more slowly. The bottom of the chamber may include a recovery system to collect the lithium. For example, the bottom of the chamber may include holes through which the lithium flows into drainpipes leading back to the external reservoir, thus completing the loop. As described above, the returning lithium may be processed to recover absorbed atoms, which may be reused (perhaps especially in the case of tritium), e.g., for NBI.

Walls of the plasma chamber may include Neutral Beam Injection (NBI) ports, vacuum turbo-pump ports, and other ports or penetrations (e.g., smaller diagnostic ports). To avoid the liquid lithium from escaping through these ports, larger ports may be vertically inclined, thus allowing accumulated liquid lithium near their openings to drip down under gravity. Some ports may also be covered with protective screens to help guide the liquid lithium around the port without interfering with, e.g., vacuum pumping.

Typical energies for NBI include 60, 120, 180 keV for neutral hydrogen, deuterium, and/or tritium. These correspond to about 30% production of the secondary charge-exchange hydrogen isotope atoms. Unconfined by the magnetic field, they escape from the plasma each carrying the plasma ion temperature. Without essential effect on heating, this loss of secondary charge-exchange atoms reduces the efficiency of NBI fueling. However, these secondary atoms (e.g., 10-30 KeV) hit the lithium surface at around 90 degrees and produce only a tolerable sputtering (compared to materials having a higher atomic number) as a contribution to the evaporation influx of lithium to the plasma. Therefore, lithium surfaces address a chief limitation of NBI in tokomaks having walls made of conventional materials (e.g., stainless steel).

FIG. 1 shows a cross section of an example plasma confinement device 100. As shown, the device includes a torus-shaped plasma vacuum chamber 110. Walls of the plasma chamber may include materials suitable for high-vacuum use, and which may allow external magnetic fields to pass through, such as stainless steel. The example plasma confinement device 100 includes one or more vacuum ports 102 which may be used to apply a vacuum to the chamber and/or measure characteristics of the chamber, such as pressure and/or partial pressures of residual gasses in the chamber. The example plasma confinement device 100 also includes one or more NBI ports 106, through which neutral beams may be injected to heat the plasma.

The example plasma confinement device 100 may include the liquid-lithium distribution manifold described above, which is configured to distribute the lithium toroidally around the plasma chamber where it moves downwardly (e.g., “creeps” under gravity at a rate of about 1 cm/second or less) along the side wall inner surfaces. The wetting of the wall surface material (e.g., stainless steel) by the creeping liquid lithium (e.g., due to interatomic electrostatic forces), serves to maintain the integrity of the liquid-lithium layer during plasma disruptions. However, this process has typically required the stainless-steel surface to reach a temperature of approximately 490 degrees C to avoid undesirable surface chemistry from occurring. However, this requirement may be relaxed by giving the liquid lithium sufficient time to dissolve any, e.g., oxide monoatomic layer, on the surface of the stainless steel.

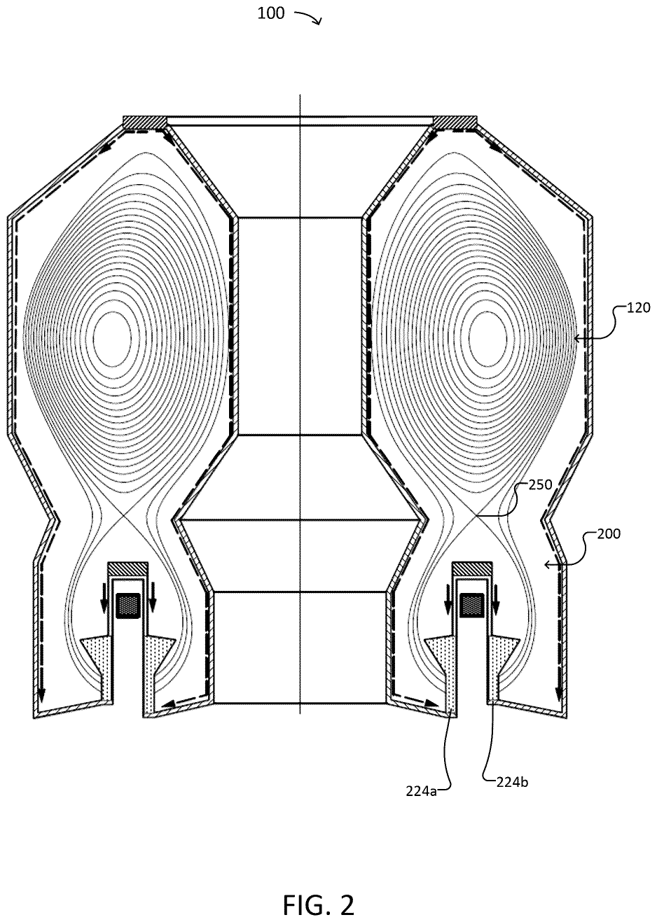

FIG. 2 shows the example plasma confinement device 100 with representative magnetic field lines shown. The plasma, which consists of charged particles, is confined within the closed magnetic field lines shown. The tokamak plasma boundary, which is typically identified with the area of open field lines known as the scrape-off layer (SOL), determines the degree of plasma-wall interaction. SOL physics is concerned with the exhaust (removal) of particles and energy from the plasma. Plasma-surface interaction (PSI) physics is among the most complex subjects in tokamak physics and is a chief cause of unpredictability of tokamak plasma and uncontrolled plasma disruptions.

An X-point is defined as a point in space at which the poloidal magnetic field has zero magnitude. The magnetic flux surface that intersects with the X-point is called the separatrix, and, as all flux surfaces external to this surface are unconfined, the separatrix defines the last closed flux surface (LCFS). The LCFS is the magnetic field boundary between the confined plasma and the open field lines that interact with, e.g., a diverter or heat sink. By establishing an X-point and separatrix, the plasma edge is uncoupled from the vessel walls, and exhausted heat and plasma particles are preferentially diverted towards a known region of the vessel near the X-point. As shown the magnetic configuration includes an X-point 250 and open magnetic field lines that terminate at one or more heat sinks 224a, 224b disposed within a heat-sink chamber 200 (rather than, e.g., a diverter). Although the heat-sink chamber 200 is shown beneath the plasma chamber, other configurations of plasma confinement devices 100 are also possible, including (but not limited to) devices 100 having a heat-sink chamber 200 disposed above the plasma chamber. As described below, the heat sinks 224a, 224b may also be coated with liquid lithium. Therefore, this SOL arrangement reduces or eliminates the plasma core interaction with any high-Z (high atomic number) materials, such as stainless steel.

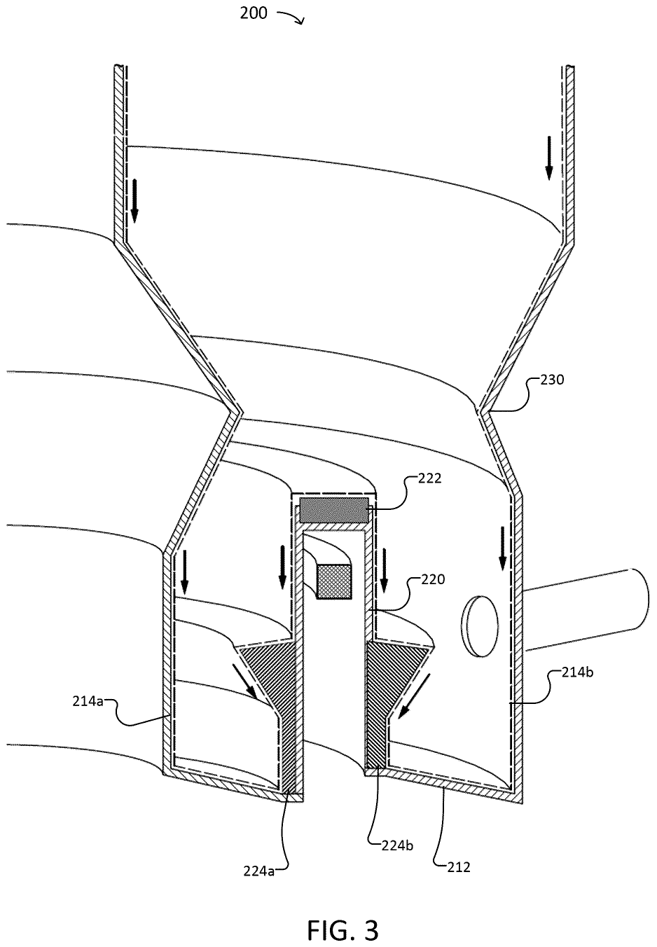

FIG. 3 shows a close-up view of the heat-sink chamber 200. As shown, the chamber includes a base 212 at the bottom of the chamber. A heat-sink structure 220 protrudes from the base. In the configuration shown in FIG. 3, the heat-sink structure 220 protrudes upwards. However, the heat-sink structure 220 may protrude in other directions as well. Furthermore, the heat-sink structure 220 is shown with a substantially rectangular cross section and occupying the center of the heat-sink chamber 200. This depiction is merely for simplicity. Other cross sections are also within the scope of this disclosure. Furthermore, the heat-sink structure 220 may occupy any portion of the heat-sink chamber 200 that allows for the open magnetic field lines terminate at one or more heat sinks 224a, 224b. Here, where the heat-sink chamber 200 is substantially toroidal in shape, the rectangular heat-sink structure 220 forms a cylinder within the toroidal heat-sink chamber 200. One or more heat sinks 224a, 224b are disposed on the heat-sink structure 220. As shown in FIG. 2 and described above, the device is configured to have open magnetic field lines that terminate at the heat sinks 224a, 224b which are configured to absorb thermal energy. In the example heat-sink chamber 200 of FIG. 3, an inner heat sink 224a is disposed on the interior portion of the cylindrical heat-sink structure 220, and an outer heat sink 224b is disposed on the opposite side of the cylindrical heat-sink structure 220 (on an exterior portion of the cylindrical heat-sink structure 220).

In some examples, the heat sinks 224a, 224b are actively cooled. That is the device 100 may include a cooling system. The cooling system may circulate a fluid, such as an oil to the heat sinks 224a, 224b, where the fluid absorbs thermal energy from the heat sinks 224a, 224b. The fluid may then be circulated away from the heat sinks 224a, 224b, thereby maintaining the temperature of the heat sinks 224a, 224b. In some examples, the thermal energy removed from the heat sinks 224a, 224b is converted into a useful form, such as electricity. The thermal energy may be converted to electricity through a steam turbine, reverse electro-dialysis system, or the like. A lithium distributor 222 is configured to provide a flow of lithium to one or more surfaces of the heat-sink structure 220. Surfaces of the heat-sink structure 220 may include surfaces of the heat sinks 224a, 224b. As shown, the lithium distributor 222 is disposed at an upper portion of the heat-sink structure 220 where gravity will naturally draw the liquid lithium downwards onto surfaces of the heat-sink structure 220 (as described above with respect to the plasma chamber). In other examples, the lithium distributor 222 may be disposed elsewhere in the heat-sink chamber 200 where it can provide a flow of lithium to surfaces of the heat-sink structure 220.

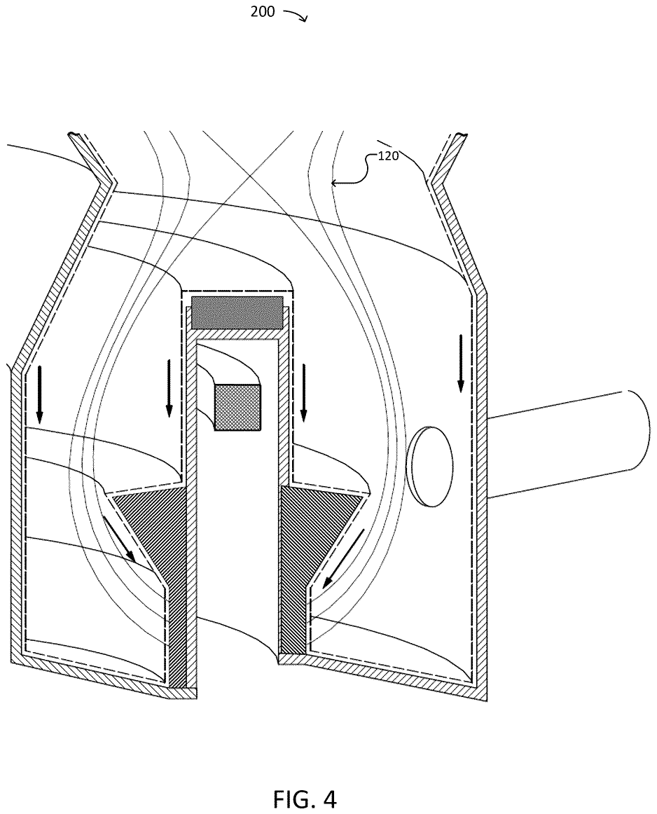

As shown, walls 214a, 214b of the heat-sink chamber 200 extend upwards from the base 212. Upper portions of the walls 214a, 214b are inclined toward each other to form a waist 230, i.e., a narrow region, that separates the heat-sink chamber 200 from the plasma chamber. The narrow region may serve to contain (within the heat-sink chamber 200) lithium that evaporates while within the heat-sink chamber 200. FIG. 4 shows the example heat-sink chamber with magnetic field lines 120 superimposed.

A plasma-confinement device 100 may include a plasma chamber adjacent to the heat-sink chamber 200 described above (and with the associated magnetic configuration). In some examples, the plasma chamber also includes a liquid lithium distribution system, such that the plasma-facing surfaces of the plasma chamber are entirely (or substantially) liquid lithium as well as the heat sinks 224 of the heat-sink chamber 200. This device 100 may be used for research as well as for power production/generation. For example, the device 100 may be used with a deuterium plasma, with its associated lower amount of energy released per fusion event. In this case, the plasma may be heated, e.g., using Electron Cyclotron Resonance Heating (ECRH), to simulate the expected effects when using deuterium-tritium (D-T) fuel. A research tokomak may have a major radius of about 2.5 meters, a plasma current of amount 2.5 megaamperes, and a toroidal field of about 3 Tesla.

An additional benefit of a liquid-lithium plasma-facing surface is that during a plasma discharge, byproducts of NBI are naturally absorbed by the lithium though plasma pumping, reducing the demand for external vacuum pumps, such as ion pumps, to maintain high vacuum. Furthermore, because the liquid-lithium plasma-facing surface reduces recycling, it effectively suppresses plasma edge cooling. This results in an edge temperature equal to:

$$\frac{Ti + Te}{2} = ( 1 - {f}^{cooling} ) * \frac{{E}_{NBI}}{5} ,$$

where E_{NBI} is the energy (in KeV) of NBI atoms, with Ti and Te for the ion end electron temperatures, respectively, and f^{cooling} representing the cooling factor, replacing the recycling coefficient of conventional tokamaks. This factor considers cooling by both charge-exchange-originated hydrogen recycling and cooling potential supersonic gas injection and by charge-exchange of plasma ions with evaporated lithium. For a cooling factor of 0.1-0.2, the average plasma edge temperature would be 9.6-10.8 keV for 60 keV hydrogen NBI or approximately double that for 120 keV deuterium NBI.

Operations with burning plasma may achieve plasma electron temperatures (Te) of approximately 20-35 keV due to additional heating from α-particles (ash). In such conditions, plasma current can be inductively maintained via a central solenoid for extended durations: e.g., up to 1-2 hours in fusion-relevant conditions or tens of minutes in research H- or D-plasmas. Furthermore, the exceptionally low scrape-off layer plasma density between the core and the chamber wall enables optimal coupling for waveguides used in the Electron Cyclotron Current Drive (ECCD). This feature allows precise adjustments to the plasma current density profile, ensuring stability control during operations.

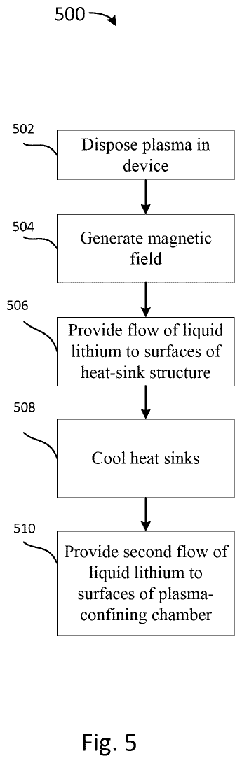

FIG. 5 shows a flowchart 500 for an example method of extracting heat from a plasma-confinement device 100. At step 502, the method includes disposing a plasma in a plasma-confinement device that includes a heat-sink chamber 200. In some examples, the plasma-confinement device 100 is a tokomak. At step 504, the method includes generating a magnetic field having open field lines that terminate at one or more heat sinks 224 of the heat-sink chamber 200. In some examples, generating the magnetic field includes generating a magnetic field having closed magnetic field lines within the plasma-confining chamber. At step 506, the method includes providing, by a lithium distributor, a flow of liquid lithium to the one or more surfaces of the heat-sink structure. In some examples, the one or more surfaces of the heat-sink structure include one or more surfaces of one or more heat sinks. At step 508, the method includes actively cooling the one or more heat sinks 224. Active cooling may include circulating a coolant, such as oil to remove thermal energy from the heat sinks 224. At step 510, the method optionally includes providing, by a second lithium distributor, a second flow of liquid lithium to one or more surfaces of a plasma-confining chamber of the plasma-confinement device 100. In some examples, the method further includes maintaining side-wall temperature of the plasma-confining chamber under 250 degrees Celsius.

Embodiments have been described in this document with the aid of functional building blocks illustrating the implementation of specified functions and relationships. The boundaries of these functional building blocks have been arbitrarily defined in this document for the convenience of the description. Alternate boundaries can be defined as long as the specified functions and relationships (or their equivalents) are appropriately performed. Also, alternative embodiments can perform functional blocks, steps, operations, methods, etc. using orderings different than those described in this document.

The features from different embodiments disclosed herein may be freely combined. For example, one or more features from a method embodiment may be combined with any of the system or product embodiments. Similarly, features from a system or product embodiment may be combined with any of the method embodiments herein disclosed.

References in this document to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Furthermore, when a particular feature, structure, or characteristic is described in connection with an embodiment, it would be within the knowledge of persons skilled in the relevant art(s) to incorporate such feature, structure, or characteristic into other embodiments, whether or not explicitly mentioned or described in this document. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but still co-operate or interact with each other.

While the invention has been described with specific embodiments, other alternatives, modifications and variations will be apparent to those skilled in the art. Accordingly, it will be intended to include all such alternatives, modifications, and variations within the spirit and scope of the appended claims.

1. A heat-sink chamber for a plasma-confinement device, the chamber comprising:
a base;
a heat-sink structure protruding from the base of the chamber, wherein the heat-sink structure comprises:
one or more heat sinks disposed on a surface of the heat-sink structure and configured to absorb thermal energy;
a lithium distributor configured to provide a flow of lithium to one or more surfaces of the heat-sink structure; and
at least one magnet configured to generate a magnetic field, the generated magnetic field including:
a closed flux surface configured to confine a plasma; and
open field lines outside of the closed flux surface, the open field lines terminating at the one or more heat sinks.

2. The heat-sink chamber of claim 1, further comprising walls extending from the base and surrounding the heat-sink structure, wherein a distance between the walls diminishes to form a waist, the waist defining an opening opposite the base of the heat-sink chamber.

3. The heat-sink chamber of claim 2, wherein at least a portion of at least one wall angles toward an opposite wall to form the waist.

4. The heat-sink chamber of claim 1, wherein the one or more heat sinks comprises two heat sinks disposed on opposite sides of the heat-sink structure such that the open field lines terminate at each of the two heat sinks.

5. The heat-sink chamber of claim 4, wherein the lithium distributor is configured to provide a flow of lithium to surfaces of each of the two heat sinks where the open field lines terminate.

6. The heat-sink chamber of claim 5, wherein each of the one or more heat sinks comprises:
an actively cooled copper body; and
a foil brazed to a surface of the copper body, wherein the lithium distributor is configured to provide the flow of lithium to coat the foil.

7. The heat-sink chamber of claim 5, wherein the lithium distributor is configured to provide the flow of lithium using gravity.

8. A plasma-confinement device comprising:
a plasma-confining chamber; and
the heat-sink chamber of claim 2 adjacent to the plasma-confining chamber, wherein the opening opposite the base of the heat-sink chamber defines an opening between the plasma-confining chamber and the heat-sink chamber.

9. A method of extracting heat from a plasma-confinement device, the method comprising:
disposing a plasma in a plasma-confinement device comprising the heat-sink chamber of claim 1;
generating the magnetic field;
providing, by the lithium distributor, the flow of liquid lithium to the one or more surfaces of the heat-sink structure; and
actively cooling the one or more heat sinks.

10. The method of claim 9, further comprising:
providing, by a second lithium distributor, a second flow of liquid lithium to one or more surfaces of a plasma-confining chamber of the plasma-confinement device.

11. The method of claim 10, further comprising:
maintaining side-wall temperature of the plasma-confining chamber under 250 degrees Celsius.

12. The method of claim 10, wherein generating the magnetic field comprises generating a magnetic field having closed magnetic field lines within the plasma-confining chamber.
